(19) United States
(12) Patent Application Publication
(10) Pub. No.: US 2016/0357879 A1
(43) Pub. Date: Dec. 8, 2016

(54) METHOD AND APPARATUS FOR CHECKING THE BUILDABILITY OF A VIRTUAL PROTOTYPE

(71) Applicant: INVENIO VIRTUAL TECHNOLOGIES GMBH, Garching bei Munchen (DE)

(72) Inventors: Tobias Beck, Munchen (DE); Hermann Gaigl, Pastetten (DE); Michael Pretschuh, Munchen (DE)

(21) Appl. No.: 15/170,594

(22) Filed: Jun. 1, 2016

(30) Foreign Application Priority Data
Jun. 5, 2015 (EP) EP15170831.0
Jun. 12, 2015 (EP) EP15171939.0

(51) Int. Cl. G06F 17/50

(52) U.S. Cl. CPC G06F 17/50; G06F 2217/12

(57) ABSTRACT

A method for checking the buildability of a virtual prototype includes an automatic ascertainment of possible problem points that may arise in the course of assembling the virtual prototype from virtual components and do not satisfy predetermined structural, physical and/or aesthetic requirements. The method includes an assessment, assisted by a computer system, of at least one of the possible problem points as a critical or uncritical problem point, depending on several structural, physical and/or aesthetic features of the respective possible problem point. Furthermore, an apparatus is proposed for checking the buildability of a virtual prototype. With methods and apparatuses according to exemplary embodiments, the effort in terms labour and time and also faulty assessments are capable of being reduced by an automatic assessment of problem points and by a more efficient assessment of problem points.

### FIELD OF THE INVENTION

The invention relates to methods and apparatuses for checking the buildability of a virtual prototype in product development, for example in the automotive, aerospace, shipbuilding, general-engineering and/or consumer-goods industry.

### BACKGROUND

Technical products are becoming ever more complex and consist nowadays of a large number of individual components which interact with one another. Prior to the formation of the first hardware prototypes, a precise digital description of the product already exists in the computer. In the course of the development process this virtual prototype is continually updated and checked for geometrical or technical/physical buildability, for example. This continuous process of testing the virtual prototype is today substantially a three-stage process which is carried out continuously and cyclically:

Stage 1: Computer-aided ascertainment of a complete list of possible problem points. In this connection, ‘completeness’ is to be understood in such a way that all ‘critical’ problem cases are to be included in the list (cf. Stage 2). These may be, for instance:
Locations at which collisions and clearance undershoots of virtual components arise in the case of static (quiescent state) or dynamic inspection (e.g. mounting or operation of the product).
Locations at which combinations and spatial neighbourhoods of components and materials arise that impair the audio-visual aesthetics of the end user, for example by creaking or rattling, or that disrupt usability.
Locations at which an endangering, capable of being ascertained by simulation, of the function of the product is present (e.g. excessive evolution of heat with simultaneous undershoot of minimal-clearance specifications, or inadequate strength of components).

Stage 2: Assessment of the possible problem points recorded on the previously ascertained list as ‘critical’ or ‘uncritical’ problem points. Only in the case of the ‘critical’ problem points is there a need for action. A computer is not capable today of performing an autonomous assessment of the possible problem points; therefore an individual assessment of the possible problem points is undertaken by human experts. The list of the possible problem points at this stage has been sorted arbitrarily without further assistance.

Stage 3: Documentation of the possible problem points, and tracking their further development or solution in the course of the lifecycle of the product (issue management), whereby, in particular, virtual component pairings together with their relative pose are tracked as possible problem points. Problem points once assessed as ‘uncritical’ are in this case no longer submitted to the expert in the next step. However, changes in respect of the tracked virtual components of the virtual product and/or in respect of the pose thereof relative to one another lead to resubmission as a possible problem point (see Stage 2).

In particular, the assessment in Stage 2 of the process described above exhibits today the following weak points:
Even possible problem points that are ‘easy to decide’ are submitted to a human assessor.
Similarity or identity amongst possible problem points is not utilised for assessment purposes.
Possible problem points in new development projects (preliminary assessment) may accrue in hundreds of thousands, or millions. However, an expert reliably assesses at most a few hundred problem points per day. This disparity of the orders of magnitude can call into question the feasibility of the preliminary assessment. In each case considerable personnel costs arise.
Human experts incline towards faulty assessments with waning concentration. This is favoured by factors such as a routine implementation of a large number of assessments or the unordered submission of various possible problem points. Faulty assessments in such an early development phase may lead to high subsequent costs in a later product phase.
Conventional software tools that an expert utilises for the purpose of assessment are not tailored to the task of the assessment and require, by reason of their complexity and irrespective of the professional qualification of the expert, intensive familiarisation and instruction. The routine implementation of a succession of always identical steps in the course of the operation of these tools is time-intensive and tiring.

For the purpose of checking the buildability of a product consisting of several components that is employed in the automotive, aerospace, shipbuilding and/or consumer-goods industry, for example, in EP 1 111 487 A1 it is proposed to evaluate in computer-aided manner, i.e. automatically, digital module data that contain spatial geometrical information about an already existing module, digital component data that contain spatial geometrical information about a component to be mounted on the module, and digital position data that describe a position sequence with at least two spatial positions, a first position corresponding to the mounted state of the component and a second position corresponding to the demounted state of the component, in order to ascertain automatically a suitable path for the mounting and/or demounting of the component, which enables a collision-free movement of the component from the first position to the second position and/or conversely.

EP 1 067 479 A1 discloses an automatic verification of the several components of a product, for example a motor vehicle, which have been designed at differing workstations in the course of the creation of a digital mapping of the product during the design phase thereof. For this purpose, the digital image data generated in the course of the computer-aided design of the individual components are read in automatically at regular intervals via a data-transmission network and are put together to form a digital mapping of the desired product. Subsequently the fit of the individual components with respect to the consequently generated digital mapping of the product is verified automatically. The verification is preferentially also carried out automatically at regular intervals and can be undertaken in both centralised and decentralised manner.

### SUMMARY OF THE INVENTION

A need exists for methods and apparatuses that make the checking of the buildability of a virtual prototype more efficient, faster and freer from errors.

According to exemplary embodiments, methods and apparatuses for checking the buildability of a virtual prototype are specified which, in particular, make the assessment of the possible problem points which may arise in the course of assembling the virtual prototype from virtual components more efficient, faster and freer from errors.

With methods and apparatuses of such a type, the number of assessments to be performed by human experts, the effort in terms of labour and time, and also the faulty-assessment rate can be reduced.

A method for checking the buildability of a virtual prototype according to an exemplary embodiment includes an automatic ascertainment of possible problem points that may arise in the course of assembling the virtual prototype from virtual components and do not satisfy predetermined structural, physical and/or aesthetic requirements. The method includes an assessment, assisted by a computer system, of at least one of the possible problem points as a critical or uncritical problem point, depending on several structural, physical and/or aesthetic features of the respective possible problem point.

The virtual components of a virtual prototype are available as a digital description, in particular in the form of CAD data, generalised voxel data or triangulations. Data pertaining to various data formats may in this connection firstly be brought into a uniform format. For the purpose of checking the buildability of the virtual prototype, its virtual components are then preferentially placed relative to one another as planned before the predetermined requirements are checked and the possible problem points are identified accordingly. The possible problem points exhibit a set of structural, physical and/or aesthetic features which is fed, in particular, from the features and properties of the virtual components involved and/or has been derived therefrom.

Examples of structural features are shape and dimensions of individual components. Physical features may be, for instance, temperature values that have been taken from a thermodynamic simulation carried out previously. Aesthetic features may be, for example, data relating to the emission of noise in the case of the combination of certain materials.

The several features of the possible problem point can be drawn upon for the purpose of assessing said problem point as critical or uncritical problem points.

The several features may encompass a cut volume of the respective possible problem point, with which some of the virtual components in the virtual prototype overlap.

A cut volume is preferentially ascertained by the geometries of the virtual components involved in a possible problem point being interpreted as solid bodies with respect to their outermost envelope and being intersected set-theoretically.

Furthermore, geometrical features derived from the cut volume can be ascertained. In addition, many of these aforementioned geometrical features or even features from the metadata thereof (e.g. material, directions on use, spatial position within the product structure, keywords such as ‘screw’, for instance) can also be taken from the individual virtual components involved.

Advantageously, cut volumes and features derived therefrom can improve the assessment of the underlying possible problem points by virtue of the fact that they make the latter better describable or distinguishable.

The assisted assessment may include a joint assessment of possible problem points that exhibit several identical features.

Advantageously, those possible problem points, the assessment of which would lead to an always identical assessment result by reason of feature identity, can be combined and assessed uniformly. This leads to a more efficient checking of the buildability of the virtual prototype. For example, feature identity obtains in the case of numerical geometrical equality.

The assisted assessment may include a classification of the respective possible problem point on the basis of the several features of the possible problem point into one of several problem classes.

The several features of a possible problem point are interpretable as a feature vector. Given choice of a suitable metric, the possible problem points can in this way be mapped into a multidimensional metrical feature space.

If suitable (distinguishing) features are present, possible problem points with similar feature values therein form, as a rule, distinguishable clusters.

Between the respective feature vectors of, in each instance, two possible problem points a difference, i.e. a distance or spacing in this multidimensional space, can be specified mathematically. This is done through choice of a suitable metric, so that a small spacing points to similarity of possible problem points. The corresponds, in particular, to a weighting of the features of a respective possible problem point such as would also be performed by a human expert in order to identify possible problem points as similar.

Certain sectors of the multidimensional space are preferably respectively assignable to a problem class into which possible problem points fall that are similar to one another. In this context, similarity is preferentially based on similar feature values of certain of the several features of the underlying possible problem points, or on a distance between their feature vectors. Accordingly, problem classes are not necessarily defined via all of the several features of the possible problem points.

Ideally included in the problem classes, given suitable definition thereof, are only those possible problem points that are to be assessed uniformly. Provided that an assessment was also carried out only for a single possible problem point, the assessment of all the other possible problem points of this problem class is subsequently established. This leads to a more efficient checking of the buildability of the virtual prototype.

At least one of the several problem classes may have been predetermined for the method sequence.

Advantageously, in this way problem classes with known assessments, for example, can be adopted from development projects already managed. This leads to a more efficient checking of the buildability of the virtual prototype, because known assessments can be adopted into the current development project.

The classification of the respective possible problem point into the predetermined problem class may include a fully automatic classification on the basis of a heuristic assessment function that is specific to the predetermined problem class.

It is advantageous for the assessment throughput, particularly in the case of preliminary assessments in a development project, if possible problem points that are included in certain problem classes and that are open to a fully automatic assessment ultimately no longer have to be submitted to a human expert for assessment, because they are to be assigned to a predetermined problem class with known assessment.

A heuristic assessment function in the present case is an assessment function that is based on experience and provides a confidence measure for the correct classification.

At least one of the several problem classes can be ascertained fully automatically during the method sequence.

A fully automatic ascertainment of problem classes can be carried out autonomously by the computer system on the basis of unsupervised machine learning. In this case, the set of all possible problem points is clustered automatically, i.e. problem classes result by reason of the reciprocal pose of the feature vectors, mapped in the metrical feature space, of the possible problem points.

Advantageously, in particular by this means a preliminary assessment is accelerated in a development project for which, to begin with, there is no suitable problem classification that states which of the several features and which value ranges of these features are best suited for forming problem classes to be assessed uniformly.

The assisted assessment may include a fully automatic linking of the respective possible problem point on the basis of a reference to an already assessed problem point that exhibits the same several features and/or the same problem class.

Advantageously, by a referral to similar problem points (i.e. problem classes) or identical problem points from preceding assessments, an assessment hint or a ready-made assessment can be taken from said assessments.

The preceding assessment may, for example, have been made in the same development project or in an earlier development project.

The assisted assessment may include a provision of further structural, physical and/or aesthetic information that is specific to the problem class of the respective possible problem point and has been derived from the several features of the possible problem point.

The enrichment by additional information can assist the human expert in recording, in a short time, all the aspects of the possible problem point submitted for assessment.

Advantageously, in addition the set of the data to be held in a memory for the checking of the buildability of the virtual prototype can be minimised, and these data can be enriched by details only when required, when the human expert turns to the possible problem point to be assessed in concrete terms.

The further information may include at least one spatial view and/or at least one cutting plane of the respective possible problem point.

The enrichment by additional spatial views and/or cutting planes can also assist the human expert in recording, in a short time, all the aspects of the possible problem point submitted for assessment.

Meaningful spatial views of cut volumes and/or cutting planes can be determined in this case, in particular, from the principal axes of the cut volume and/or of the virtual components involved.

The assisted assessment may include a sorting of the possible problem points into an assessment sequence on the basis of the problem class of the respective possible problem point.

It is advantageous for the faulty-assessment rate and for the assessment throughput of a human assessor if possible problem points that are similar to one another are submitted for assessment consecutively, so that the context of the possible problem points submitted for assessment does not continually change.

The problem class can be utilised as a criterion for a sorting of the possible problem points, since, by definition, possible problem points that are similar to one another are included in said class.

Additionally, a sorting can also be performed within problem classes, for example on the basis of the values of at least one feature of the respective possible problem point.

The assisted assessment may furthermore include a sorting of the possible problem points into an assessment sequence on the basis of one of several priority levels that is specific to the problem class of the respective possible problem point, each of the several priority levels corresponding to a differently critical problem point.

It is advantageous for the early elimination of particularly critical possible problem points in the development process if these are submitted for assessment as a matter of priority. Consequently, less critical possible problem points can also become invalid as a result.

The several priority levels are preferably derived within the scope of a recourse to development projects already managed. Alternatively, a fixed default is also possible.

The assisted assessment may include an assignment of the possible problem points to available assessment periods on the basis of one of several complexity levels that is specific to the problem class of the respective possible problem point, each of the several complexity levels corresponding to a different degree of complexity in the course of assessing the respective possible problem point.

It is advantageous for the faulty-assessment rate and for the assessment throughput of a human expert if the latter can decide (cause to be decided) when he/she would like to assess which problem classes. Accordingly, phases of high powers of concentration (e.g. in the morning) are particularly suitable for problem classes that are difficult to assess, whereas problem classes that are easy to assess can also be assessed in between.

The several complexity levels and the time-of-day assessment periods best suited for them in the given case can preferentially be derived from development projects already managed or alternatively can be predefined.

The assisted assessment may include a user guidance, which is specific to the problem class of the respective possible problem point, for assisting a user in the course of assessing the respective possible problem point.

For the assessment throughput of a human expert it is advantageous if a guided assessment that has been tailored to the problem class of the possible problem point to be assessed is undertaken by means of a user guidance. In this case, in the course of the implementation of his/her assessment task the human expert is guided, in a manner similar to a wizard function, through a series of operating steps that are specific to the underlying problem class.

Preferentially in this case, efforts in terms of familiarisation and instruction of the human expert for functionally overdimensioned CAD applications that are used conventionally are also dispensed with.

The assisted assessment may include a fully automatic assessment of the respective possible problem point on the basis of an assessment function, learned by a user under supervision, that is specific to the problem class of the respective possible problem point.

A fully automatic assessment can accordingly also be undertaken by means of an assessment function learned when supervised and based on machine learning. This preferably takes place accompanied by specification of a series of problem classes with associated assessments, which are then learned on the basis of training data. The training data can, in principle, be taken from any system for problem-point management.

The assessment function is preferentially capable, after training, of providing correct assessments relating for feature vectors that are new but similar to the learned training data. These assessments can be adopted directly in the case of faulty-assessment rates that lie below that those of human assessors. Alternatively, sampling inspections may be performed by the human assessor.

A data carrier with computer-readable instructions according to an exemplary embodiment may have been configured in such a manner that in the course of execution by a computer system said instructions cause said system to implement the method according to an exemplary embodiment.

An apparatus for checking the buildability of a virtual prototype according to an exemplary embodiment includes a problem-point-ascertainment device that has been set up to assemble the virtual prototype from virtual components and to ascertain automatically possible problem points that may arise in the course of assembling and do not satisfy predetermined structural, physical and/or aesthetic requirements. The apparatus is characterised by an assessment device that has been set up to assist an assessment of at least one of the possible problem points as a critical or uncritical problem point, depending on several structural, physical and/or aesthetic features of the respective possible problem point.

The assessment device may be constituted by a computer system.

In particular, a computer system designed in accordance with the von Neumann architecture, the Harvard architecture or a mixed type of these architectures can be employed as assessment device.

The problem-point-ascertainment device may be the assessment device at the same time.

A doubling-up of problem-point-ascertainment device and assessment device may be advantageous, in particular, when a separate problem-point-ascertainment device for the assembling of the virtual prototype from virtual components and for the automatic ascertainment of the possible problem points does not already come into operation. As a result, it is possible to simplify the IT infrastructure to be provided.

The assessment device may have been configured to implement the method according to an exemplary embodiment.

Accordingly, the aforementioned features of the method can be utilised analogously in the apparatus.

Methods and apparatuses according to exemplary embodiments may, in particular, make the step of assessment of possible problem points, which may arise in the course of assembling the virtual prototype from virtual components, more efficient, faster and freer from errors.

Various effects can be achieved with methods and apparatuses according to exemplary embodiments. In particular, the proportion of the assessments to be performed by human experts, the effort in terms of labour and time for the assessment, and also the faulty-assessment rate can be reduced.

Methods and apparatuses according to exemplary embodiments consequently permit a more extensive automation of virtual product development.

### BRIEF DESCRIPTION OF THE FIGURES

The invention will be elucidated in more detail in the following with reference to the drawings on the basis of preferred embodiments. In the drawings, identical reference symbols denote identical elements.

FIG. 1 shows a flow chart of a method according to an exemplary embodiment.

FIG. 2 shows a flow chart of a second step of the method according to the exemplary embodiment.

FIG. 3 shows a schematic block diagram of a system with an apparatus according to an exemplary embodiment.

FIG. 4 shows a schematic view of a cut volume of an exemplary possible problem point.

FIG. 5 shows a schematic view of a multi-stage assessment sequence for possible problem points according to an exemplary embodiment.

FIG. 6 shows a flow chart of a user guidance in the course of assessing a possible problem point according to an exemplary embodiment.

### DETAILED DESCRIPTION OF EXEMPLARY EMBODIMENTS

In the following the present invention will be elucidated in more detail on the basis of preferred embodiments with reference to the drawings. In the Figures, identical reference symbols denote identical or similar elements. The Figures are schematic representations of various embodiments of the invention. Elements represented in the Figures have not necessarily been represented true to scale. Rather, the various elements represented in the Figures have been reproduced in such a manner that their function and their purpose become intelligible to a person skilled in the art.

Connections and couplings, represented In the Figures, between functional units and elements may also be implemented as an indirect connection or coupling. A connection or coupling may have been implemented in hard-wired or wireless manner.

Methods and apparatuses for checking the buildability of a virtual prototype—for instance from the automotive, aerospace, shipbuilding, general-engineering and/or consumer-goods industry—will be described in detail in the following.

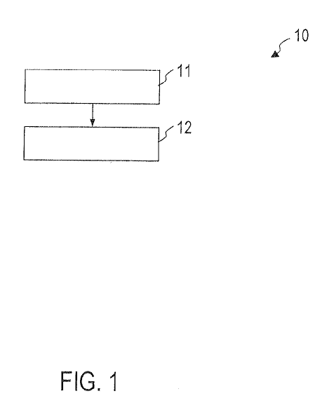

FIG. 1 shows a flow chart of a method 10 according to an exemplary embodiment.

In said Figure the two method steps 11 and 12 are represented. In the first step 11, possible problem points that may arise in the course of assembling the virtual prototype from virtual components and do not satisfy predetermined structural, physical and/or aesthetic requirements are ascertained automatically. Examples of such requirements are ‘clearance too small’, ‘temperature too high’ or even ‘materials X and Y abutting one another’.

The second step 12 includes an assessment, assisted by a computer system, of at least one of the ascertained possible problem points. The objective in this step is a differentiation into critical or uncritical problem points. This is done as a function of several features of the respective possible problem point, which, as already mentioned further above, may likewise may be of structural, physical and/or aesthetic nature.

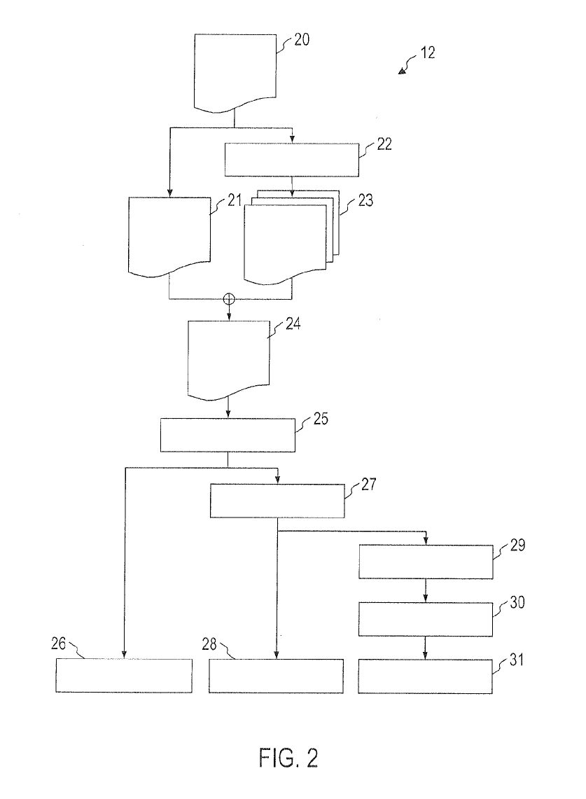

FIG. 2 shows a flow chart of the second method step 12 of the method 10 according to the exemplary embodiment.

The starting-point of the further sequence of the method is one of the ascertained possible problem points 20.

For an assessment, assisted by a computer system, it is firstly necessary to describe the possible problem point 20 with features in such a way that it is differentiable from possible problem points 20 of a different kind.

For this purpose, on the one hand, properties 21 can be taken as features from the metadata of the components involved in the respective possible problem point 20, such as, for instance, type of material, directions on use, spatial position within the product structure, or keywords such as ‘screw’, for example.

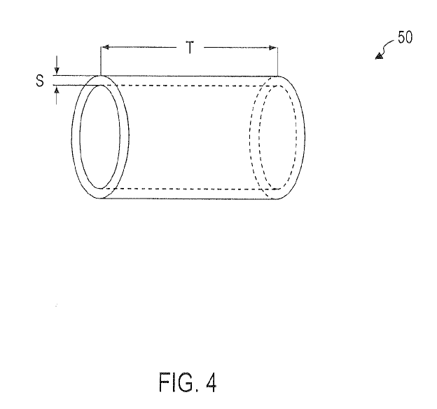

On the other hand, each possible problem point 20 exhibits a spatial-geometrical extent which, on the basis of a cutting calculation 22, is capable of being represented as a cut volume and/or in the form of cutting planes. An example of a cut volume in respect of a possible problem point 20, which comes about by virtue of a component pairing consisting of a screw and a drill-hole, is represented further below in FIG. 4. From the result of the cutting calculation 22, geometrical properties 23 are capable of being derived which may also serve as features for describing the possible problem point 20. These are, for example, a pointwise depth of penetration, a displacement volume of the collision, properties of the surface, a ratio of surface area to volume, a spatial distribution of density and volume of the sectional geometry, as well as, ascertained therefrom, Fourier coefficients, principal axes and ratios of dimension, return vectors (i.e. displacements of the virtual components involved, which eliminate an ascertained component overlap) and also properties of the cutting line.

This set or a subset of the ascertained features of the possible problem point 20 constitutes a feature vector 24 which in the further sequence ensures the differentiability of the possible problem points 20.

By means of a suitable metric which serves for weighting the individual features of a feature vector 24, the respective feature vectors 24 of possible problem points 20 that are similar or identical to one another are also mapped in spatial proximity to one another in a multidimensional metrical feature space. Each subspace of the feature space that includes such a cluster of feature vectors 24 may represent a problem class of possible problem points 20 that are similar or identical to one another and that, in particular, are to be assessed as similar or identical.

An assessment, assisted by a computer system, of a possible problem point is therefore based on a classification 25 of the possible problem point 20 into one of several problem classes of such a type.

Individual problem classes may have been predetermined. For example, for the frequently arising possible problem point 20 of the component pairing consisting of screw and drill-hole the specification of a characteristic problem class is conceivable. The classification 25 of the possible problem point 20 into the problem class predetermined for the component pairing consisting of screw and drill-hole can be undertaken, for example, by a heuristic assessment function which has the aim that the keyword ‘screw’ is contained in the metadata of one of the two virtual components and that a confidence measure of the geometrical concordance between the model conception of a ‘length of pipe’ (see description of the Figures relating to FIG. 4) and the ascertained cut volume exceeds a predetermined threshold. In principle, false classifications are permitted in this case, though they should occur more rarely than in the case of a human assessor.

Individual problem classes can also be ascertained fully automatically. These correspond to the clusters, mentioned further above, of feature vectors 24 in the multidimensional feature space, which are learnable, for instance without supervision by a user (unsupervised learning), for example with the so-called expectation-maximisation algorithm (EM algorithm).

Depending on the classification 25, some of the several problem classes may already be open to a fully automatic assessment 26 which is undertaken on the basis of an assessment function learned by a user (supervised learning).

The fully automatic assessment 26 associates unknown input parameters (here, the elements of the feature vector 24) with the respectively correct output parameter (assessment as ‘critical’ or ‘uncritical’), provided that such an association (assessment function) was learned in a preliminary, supervised training phase accompanied by specification of learning data. In particular, assessments, made in the past, of possible problem points 20 serve as learning data. The assessment function can be realised with an artificial neural network, for example. The fully automatic assessment 26 can therefore appraise not only pairings, previously trained explicitly, of input and output parameters but also, in particular, unknown pairings (learning transfer).

If a fully automatic assessment 26 is still not possible for the problem class of the possible problem point 20, where possible a linking 27 is undertaken of the possible problem point 20 with a problem point, assessed in the past, of the same problem class. The linking 27 may also already be undertaken implicitly by virtue of the classification 25. So a recourse to known assessments takes place, which is undertaken not by learning but by an assignment on the basis of the problem class of the present possible problem point 20. If a similar or identical problem point was already classified identically in the past and subjected to an assessment, this assessment can then also be utilised for the present possible problem point 20.

Consequently the linking 27 can make other of the several problem classes open to a fully automatic assessment 28 which utilises the assessment of the problem point assessed in the past. However, if the linking 27 of the possible problem point 20 comes to nothing, a human assessor has to take over the assessment.

Ahead of this, a provision 29 is firstly undertaken of further structural, physical and/or aesthetic information that is specific to the problem class of the respective possible problem point 20. In particular, this information is constituted by spatial views and/or cutting planes recorded automatically from a perspective that is relevant to the underlying problem class.

The additional information can make the foundations of the decision more meaningful and can spare the human user time-consuming alternations between various development tools and/or drawing views.

The possible problem point 20 is preferably submitted to the human user not at random but together with possible problem points 20 of the same type. For this purpose, a sorting 30 of the possible problem points 20 into an assessment sequence and/or with respect to available assessment periods may take place.

The sorting 30 may include several sorting criteria, including a priority level, the problem class and/or a complexity level of the respective possible problem point 20.

The sorting criterion of the priority level enables a prioritising of the assessment of certain problem classes at the expense of others. Assessments that are particularly urgent for the development process can be favoured in this way.

Alternatively or additionally, the problem class can be employed as sorting criterion. This ensures that the assessment context does not change with each newly submitted possible problem point 20, but rather that possible problem points 20 of the same type are submitted for assessment successively.

The complexity level of the possible problem point 20 is available as a further sorting criterion. Therefore, however, a linear sorting does not take place, but rather an assignment 30 of the possible problem points 20 to available assessment periods. In this way, more complex possible problem points 20 can be assessed in periods in which human assessors are most efficient.

Finally, by means of an assessment tool which realises a user guidance that is specialised for the problem class of the possible problem point 20, the assessment 31 of the possible problem point 20 is undertaken by the human assessor. In this case, possible problem points 20 that are similar or identical to one another can be assessed jointly. For example, there is no reason not to rate a large number of screw/drill-hole component pairings jointly as ‘uncritical’ that were classified into a problem class provided for them.

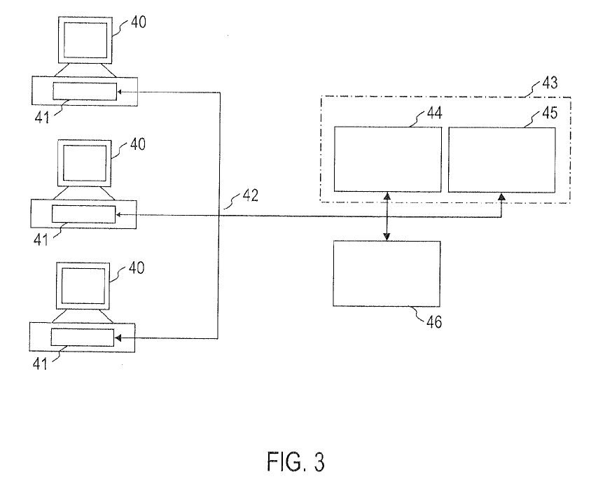

FIG. 3 shows a schematic block diagram of a system with an apparatus 43 for checking the buildability of a virtual prototype according to an exemplary embodiment.

In the case of the system shown in FIG. 3, the individual components of a product, for example a vehicle, are being designed in computer-aided manner at various workstations. The workstation computers 40 represented in this case are CAD systems that generate digital 3D design data pertaining to the respective component and store these data in memories 41 which, as a rule, are commercial mass-storage devices (fixed discs). These have been provided in decentralised manner at the respective workstation 40 and/or centrally, for example in computing centres.

The workstation computers 40 and memories 41 may, in principle, have been distributed worldwide and may be accessible for an exchange of data by means of appropriate communication interfaces. In this case a communications network 42 connects the memories 41 to a central apparatus 43 for checking the buildability of a virtual prototype according to an exemplary embodiment, said apparatus having likewise been integrated into the communications network 42 via appropriate communication interfaces. The communications network 42 has been configured to be cabled and/or wireless. In particular in this context, an exchange of data via the Internet, or a radio transmission, for example via a mobile-radio network, is also conceivable.

The apparatus 43 exhibits apparatus features that are analogous to the features of the method 10. These include, as represented in FIG. 3, at least one problem-point-ascertainment device 44 and also an assessment device 45.

The problem-point-ascertainment device 44 has been set up to assemble the digital 3D design data that are held pertaining to the individual components so as to form a digital mapping of the overall product, the so-called virtual prototype, and to store the latter in a central memory device 46 provided for it. For this purpose the device 44 can access the digital 3D design data, held in the memories 41, pertaining to the respective components.

In the respective workstation computers 40, use is preferentially made, for each component, of that CAD system which is best suited for the design of this component. Accordingly, digital 3D design data pertaining to the individual components are available which may exhibit differing data formats and mostly comprise a very large volume of data. The problem-point-ascertainment device 44 can convert these digital 3D design data exactly describing the respective component into a neutral, approximated data format, the so-called voxel format, which has been reduced to what is essential. The CAD models of the components of the product to be developed are, for example, converted into corresponding voxel models, triangulations or such like, simultaneously greatly reducing the accruing volume of data. Hence, for example, a visualisation of complete products, such as vehicles for instance, becomes feasible.

Furthermore, the problem-point-ascertainment device 44 has been set up to ascertain automatically, in the course of assembling component pairings of the virtual prototype, possible problem points arising that do not satisfy predetermined structural, physical and/or aesthetic requirements.

The task of the assessment device 45, on the other hand, is to assist in assessing at least one of the possible problem points as a critical or uncritical problem point, depending on several structural, physical and/or aesthetic features of the respective possible problem point.

With respect to the apparatus 43, diverse modifications are conceivable. For example, the assessment device 45 may be constituted by a computer system. Furthermore, the problem-point-ascertainment device 44 may be the assessment device 45 at the same time. The assessment device 45 may, in particular, have been configured to implement the method 10 according to the exemplary embodiment.

FIG. 4 shows a schematic view of a cut volume 50 of an exemplary possible problem point 20.

In the example shown, it is a question of the cut volume 50 of a component pairing consisting of screw and drill-hole. The screw thread has typically not been fully designed but has been approximated from outside by a cylinder, the radius of which is greater than that of the associated drill-hole. The cut volume 50, ascertained in the step of the cutting calculation 22 (cf. FIG. 2), of the component pairing therefore forms the shape of a length of pipe which is open at both ends and bounded by two cylinders and two planes. The difference S of the cylinder radii corresponds in this case to the thickness of the thread, and the spacing T of the two boundary planes corresponds to the depth of penetration of the screw. This spatial-geometrical model, which is easy to describe, of the cut volume of such a component pairing can be compared with the spatial-geometrical extent of a possible problem point 20, in order to classify said problem point as pertaining to the ‘screw/drill-hole’ problem class.

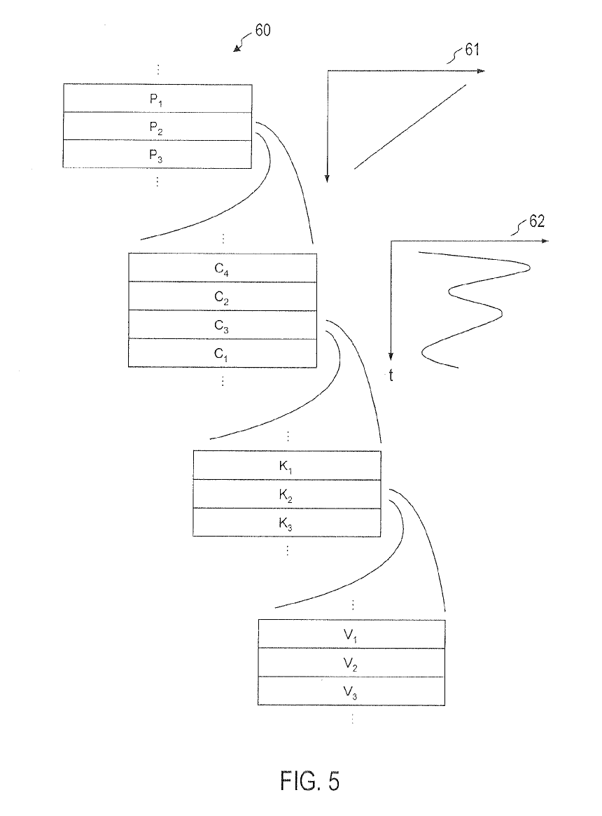

FIG. 5 shows a schematic view of a multi-stage assessment sequence 60 for possible problem points 20 according to an exemplary embodiment. In this case, for the sake of clarity merely the sorting criteria of the possible problem points 20 have been represented.

In the example shown in FIG. 5, from top to bottom the four cascaded sorting criteria of priority level Pᵢ of complexity level Cᵢ, of problem class Kᵢ and of value Vᵢ of a feature of the possible problem points 20 have been illustrated.

Priority level Pᵢ can bring about a prioritised assessment of the possible problem points 20. This linear type of sorting is indicated in the schematic diagram 61 which towards the right reflects priority level Pᵢ and towards the bottom reflects the assessment sequence.

Furthermore, FIG. 5 shows, within a priority level Pᵢ, an assignment, undertaken on the basis of the respective complexity level Cᵢ, of the respective possible problem point 20 to various time-of-day assessment periods in which the efficiency of the human assessors is variably high. The schematic diagram 62 shows towards the right an efficiency of average human assessors over a time of day t plotted towards the bottom. An optimal assignment of possible problem points 20 to time-of-day assessment periods is, as a typical optimisation task, open to appropriate solution approaches.

FIG. 5 shows, moreover, within a group of possible problem points 20 with identical complexity level Cᵢ, a sorting according to problem class Kᵢ of the possible problem points 20 and also, within a group of possible problem points 20 with identical problem class Kᵢ, a sorting according to the values Vᵢ of an arbitrary feature of the possible problem points 20.

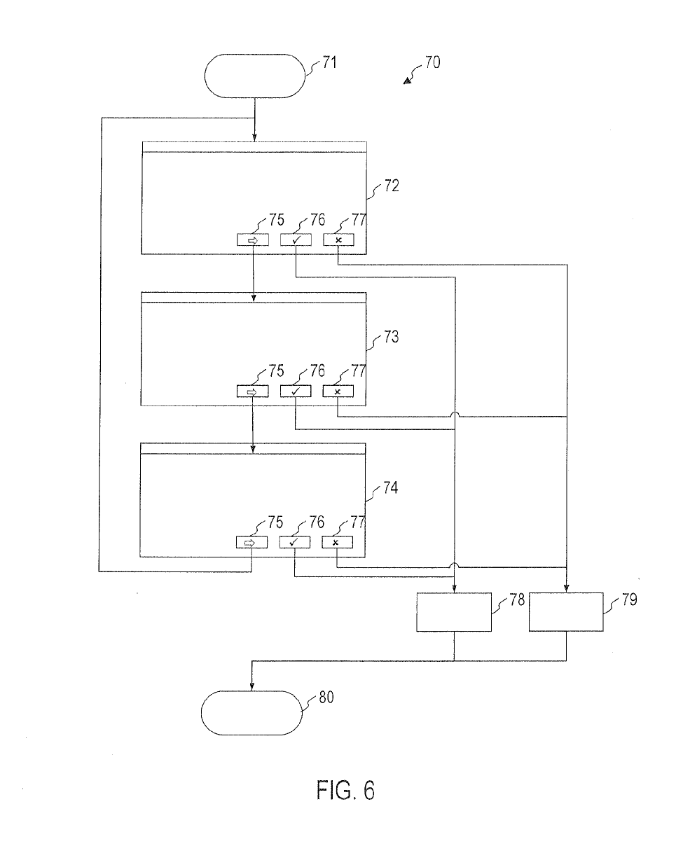

FIG. 6 shows a flow chart of a user guidance 70 in the course of assessing a possible problem point 20 according to an exemplary embodiment.

In this case, beginning at the starting-point 71 a succession of user dialogues 72, 73, 74 is run through which are each provided with operating elements 75, 76, 77. By actuation of operating element 75, a branching occurs to the respectively following user dialogue 73, 74, 72. The human assessor can alternate arbitrarily often between these user dialogues 72, 73, 74, in order, for example, to take a close look at various views or information relating to a possible problem point 20.

From the user dialogues 72, 73, 74, in each instance by actuation of operating element 76 an assessment 78 as an uncritical problem point can take place, or by actuation of operating element 77 an assessment 79 as a critical problem point can take place. Hence in both cases the end-point 80 of the user guidance 70 for the assessment of the possible problem point 20 has been reached.

Whereas exemplary embodiments have been described in detail with reference to the Figures, in further exemplary embodiments use may be made of alternative or additional features.

Methods and apparatuses according to exemplary embodiments have been described with reference to the development of individual products, but they may also be employed in the development of entire product lines and/or product platforms.

Various effects can be achieved with apparatuses and methods according to exemplary embodiments. In particular, this relates to a reduction of the proportion of the assessments to be performed by human experts, of the effort in terms of labour and time for the assessment, and also of the faulty-assessment rate.

### REFERENCE SYMBOLS

10 Method

11-12 Method steps

20 Possible problem point

21 Properties from metadata

22 Cutting calculation

23 Geometrical properties

24 Feature vector

25 Classifying

26 Fully automatic assessment on the basis of learned assessment function

27 Fully automatic linking

28 Fully automatic assessment on the basis of linking

29 Provision of further information

30 Sorting into an assessment sequence, assignment to assessment periods

31 User-guided assessment

40 Workstation computer

41, 46 Memories

42 Communications network

43 Apparatus

44 Problem-point-ascertainment device

45 Assessment device

50 Cut volume

61, 62 Diagrams

70 User guidance

71 Starting-point

72, 73, 74 User dialogues

75, 76, 77 Operating elements

78 Assessment as uncritical problem point

79 Assessment as critical problem point

80 End-point

S Thread thickness

T Depth of penetration

Pᵢ Priority measures

Cᵢ Complexity measures

Kᵢ Problem classes

Vᵢ Feature values

t Time of day

1. A method for checking the buildability of a virtual prototype, comprising the steps:
automatically ascertaining possible problem points that may arise in the course of assembling the virtual prototype from virtual components and do not satisfy predetermined structural, physical and/or aesthetic requirements; and
assessing, assisted by a computer system, at least one of the possible problem points as a critical or uncritical problem point, depending on several structural, physical and/or aesthetic features of the respective possible problem point.

2. The method according to claim 1, wherein the several features include a cut volume of the respective possible problem point, with which some of the virtual components in the virtual prototype overlap.

3. The method according to claim 1, wherein the assisted assessing includes a joint assessing of possible problem points that exhibit several identical features.

4. The method according to claim 1, wherein the assisted assessing includes a classification of the respective possible problem point into one of several problem classes on the basis of the several features of the possible problem point.

5. The method according to claim 4, wherein at least one of the several problem classes has been predetermined for the method sequence.

6. The method according to claim 5, wherein the classification of the respective possible problem point into the predetermined problem class includes a fully automatic classification on the basis of a heuristic assessment function that is specific to the predetermined problem class.

7. The method according to claim 4, wherein at least one of the several problem classes is ascertained fully automatically during the method sequence.

8. The method according to claim 4, wherein the assisted assessing includes a fully automatic linking of the respective possible problem point on the basis of a reference to an already assessed problem point that exhibits the same several features and/or the same problem class.

9. The method according to claim 4, wherein the assisted assessing includes a providing of further structural, physical and/or aesthetic information that is specific to the problem class of the respective possible problem point and has been derived from the several features of the possible problem point.

10. The method according to claim 9, wherein the further information includes at least one spatial view and/or at least one cutting plane of the respective possible problem point.

11. The method according to claim 4, wherein the assisted assessing includes a sorting of the possible problem points into an assessment sequence on the basis of the problem class of the respective possible problem point.

12. The method according to claim 4, wherein the assisted assessing includes a sorting of the possible problem points into an assessment sequence on the basis of one of several priority levels that is specific to the problem class of the respective possible problem point, each of the several priority levels corresponding to a differently critical problem point.

13. The method according to claim 4, wherein the assisted assessing includes assigning the possible problem points to available assessment periods on the basis of one of several complexity levels that is specific to the problem class of the respective possible problem point, each of the several complexity levels corresponding to a different degree of complexity in the course of assessing the respective possible problem point.

14. The method according to claim 4, wherein the assisted assessing includes a user guidance, which is specific to the problem class of the respective possible problem point, for assisting a user in the course of assessing the respective possible problem point.

15. The method according to claim 4, wherein the assisted assessing includes a fully automatic assessing of the respective possible problem point on the basis of an assessment function, learned by a user under supervision, that is specific to the problem class of the respective possible problem point.

16. A data carrier with computer-readable instructions that have been configured in such a manner that upon execution by a computer system they cause the computer system to carry out the method according to claim 1.

17. An apparatus for checking the buildability of a virtual prototype, comprising:
a problem-point-ascertainment device that is configured to assemble the virtual prototype from virtual components and to ascertain automatically possible problem points that may arise in the course of assembling and do not satisfy predetermined structural, physical and/or aesthetic requirements; and
an assessment device that is configured to automatically assist an assessment of at least one of the possible problem points as a critical or uncritical problem point, depending on several structural, physical and/or aesthetic features of the respective possible problem point.

18. The apparatus according to claim 17, wherein the assessment device is constituted by a computer system.

19. The apparatus according to claim 17, wherein the problem-point-ascertainment device is the assessment device at the same time.

20. The apparatus according to claim 17, wherein the assessment device is configured to carry out the method according to claim 1.
